(19) United States
(12) Patent Application Publication
(10) Pub. No.: US 2014/0079325 A1
(43) Pub. Date: Mar. 20, 2014

(54) IMAGE INFORMATION PROCESSING SYSTEM, IMAGE INFORMATION PROCESSOR AND RECORDING MEDIA

(71) Applicant: Buffalo Inc., Nagoya-shi (JP)

(72) Inventors: Kenji TAKAHASHI, Nagoya-shi (JP); Hayato Kato, Nagoya-shi (JP); Hiroaki Kawasaki, Nagoya-shi (JP)

(73) Assignee: Buffalo Inc., Nagoya-shi (JP)

(21) Appl. No.: 14/021,709

(22) Filed: Sep. 9, 2013

(30) Foreign Application Priority Data
Sep. 14, 2012 (JP) 2012-203503

(51) Int. Cl. G06F 17/30

(52) U.S. Cl. CPC G06F 17/30247
USPC 382/224

(57) ABSTRACT

An information processing apparatus that stores first image data in a memory; acquires second image data; determines whether the second image data is similar to the first image data; acquires a first rating corresponding to the first image data and a second rating corresponding to the second image data; and replaces the first image data stored in the memory with the second image data acquired via a communication interface when it is determined that the second image data is similar to the first image data and the second rating is higher than the first rating.

### CROSS REFERENCE TO RELATED APPLICATION

The present application claims priority to Japanese Patent Application No. 2012-203503 filed in Japan on Sep. 14, 2012, the disclosure of which is incorporated herein by reference.

### FIELD OF THE DISCLOSURE

One form of the present disclosure relates to an image information processing system, image information processor and recording media.

### RELATED ARTS

Recent years have seen widespread use of even a variety of devices such as cameras as well as mobile phones incorporating, for example, functionalities to shoot and view pictures. If image data of pictures is shared between these devices, two or more pieces of image data relating to the same image data may be spread and held by various devices. Further, such image data spread and held may be adjusted in terms of image size or encoding scheme despite the fact that the origin of these pieces of image data is the same image data.

For this reason, Japanese Patent Laid-Open No. 2007-201861 discloses a technique designed, for example, to transfer image data from a camera to a server. This technique generates a hash value of image data to be transferred and that of image data already held by the server and compares these hash values, selectively transferring image data that has yet to be held by the server.

Further, Japanese Patent Laid-Open No. 2006-81119 discloses a technique designed to replace image data (related image data) that can be regarded as substantially same as acquired image data with link information and manage such link information.

However, the above techniques have not considered a case in which a plurality of pieces of image data may be different in size or may be, due to adjustment, different in image quality despite that fact that the origin of these pieces of image data is the same image data. That is, there can be pieces of image data that differ in appearance rating such as amount of block noise because of the change of the size of image data or the difference in encoding method of image data. Therefore, controlling a server or device which accumulates and holds image data in such a manner as to simply replace image data or simply not do so because of the existence of similar data leads to failure to effectively take advantage of image data that is better rated in appearance such as that with lower block noise.

The present disclosure has been made in light of the foregoing, and it is desirable to provide an image information processing system, image information processor and recording media that can process image data in consideration of the possible presence of a plurality of pieces of image data relating to the same image data that differ in size or in image quality due to adjustment.

### SUMMARY

It should be noted that the image information processor and so on according to the present disclosure have the following features.

An image information processing apparatus according to one form of the present disclosure stores first image data in a memory; acquires second image data; determines whether the second image data is similar to the first image data; acquires a first rating corresponding to the first image data and a second rating corresponding to the second image data; and replaces the first image data stored in the memory with the second image data acquired via a communication interface when it is determined that the second image data is similar to the first image data and the second rating is higher than the first rating.

### BRIEF DESCRIPTION OF DRAWINGS

FIG. 1 is a block diagram illustrating a configuration example of an image information processing system according to one aspect of an embodiment of the present disclosure;

FIG. 2 is an explanatory diagram illustrating an example of content of an image database held by an image information processor according to one aspect of an embodiment of the present disclosure;

FIG. 3 is a functional block diagram illustrating an example of the image information processor according to one aspect of an embodiment of the present disclosure;

FIG. 4 is a flowchart illustrating an example of a process performed by the image information processor according to one aspect of an embodiment of the present disclosure;

FIG. 5 is a flowchart illustrating an example of a process performed by the image information processor according to another aspect of an embodiment of the present disclosure; and

FIG. 6 is a flowchart illustrating an example of a process performed by the image information processor according to still another aspect of an embodiment of the present disclosure.

### DESCRIPTION OF THE DISCLOSURE

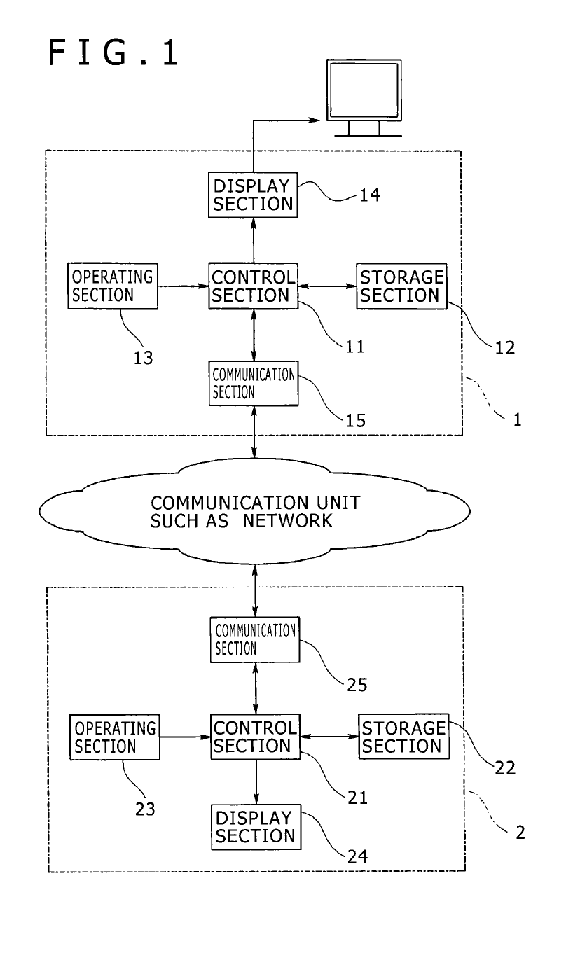

An image information processing system according to one aspect of an embodiment of the present disclosure includes an image information processor 1 as illustrated in FIG. 1. The image information processor 1 is connected to an image supplying device 2, thus the image information processor 1 is able to communicate with the image supplying device 2.

The image information processor 1 includes a control section 11, storage section 12, operating section 13, display section 14 and communication section 15. Further, the image supplying device 2 includes a control section 21, storage section 22, operating section 23, display section 24 and communication section 25. In one aspect of the present embodiment, the storage section 12 of the image information processor 1 serves as a holding section adapted to accumulate and hold image data.

The control section 11 of the image information processor 1 is a program-controlled device such as CPU (Central Processing Unit), and operates according to the program stored in the storage section 12. In one aspect of the present embodiment, the control section 11 is connected to the storage section 12, thus the control section 11 is able to communicate with the storage section 12. Further, the control section 11 serves as an image data reception portion adapted to receive image data to be accumulated. In one aspect of the present embodiment, the control section 11 determines whether image data similar to image data to be accumulated is already held by the storage section 12 and, if so, calculates a predetermined rating of each piece of similar image data. Then, the control section 11 compares the calculated ratings and controls in such a manner as to replace image data already held by the storage section 12 with the image data to be accumulated if the image data to be accumulated is similar to and rated higher than the image data already held by the storage section 12. The nature of this process performed by the control section 11 will be described in detail later.

The storage section 12 is a device such as memory device or disk device and stores a program to be executed by the control section 11. This program may be supplied stored on a computer-readable non-transitory recording media such as DVD-ROM (Digital Versatile Disc Read Only Memory) and loaded into the storage section 12. Alternatively, this program may be distributed via a communication unit such as network and loaded into the storage section 12. On the other hand, the storage section 12 also serves as a work memory of the control section 11.

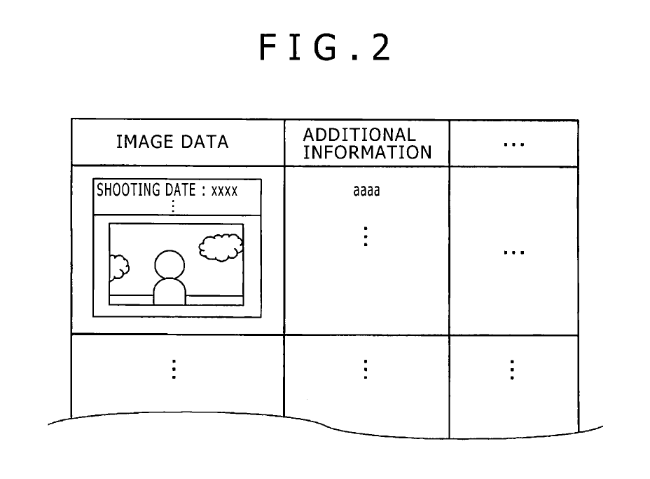

As already described earlier, the storage section 12 accumulates and holds image data in an image database as illustrated in FIG. 2. Image data is in Exif (Exchangeable image file format) format and includes a shooting date and GPS (Global Positioning System) information in addition to data body representing an image. Further, other tag information such as a list of character strings specified by the user may be associated with this image data.

The operating section 13 includes switches, remote controller and so on. The same section 13 outputs, in response to an operation of the user, a signal representing the nature of the operation to the control section 11. The same section 11 decodes this signal, thus acquiring information representing the nature of the operation. The display section 14 is, for example, an output port to a home television set or display device, and outputs display information to the television set or display device in accordance with an instruction supplied from the control section 11. Alternatively, the display section 14 may be a display device in itself.

The communication section 15 has network interface, Bluetooth (registered trademark) and other circuitry, and outputs image data received via a communication unit such as a network to the control section 11. Further, the same section 15 sends out a variety of data (including request commands) via a communication line such as a network in accordance with an instruction supplied from the control section 11.

The control section 21 of the image supplying device 2 is a program-controlled device such as CPU, and operates according to the program stored in the storage section 22. In one aspect of the present embodiment, the control section 21 transmits image data stored in the storage section 22 via the communication section 25 in accordance with an instruction of the user.

The storage section 22 is a device such as memory device or disk device and stores a program to be executed by the control section 21. This program may be supplied stored on a computer-readable non-transitory recording media such as DVD-ROM and loaded into the storage section 22. Alternatively, this program may be distributed via communication lines such as a network and loaded into the storage section 22. On the other hand, the storage section 22 serves also as a work memory of the control section 21.

The operating section 23 includes numeric keypads, touch panel and so on. The same section 23 outputs, in response to an operation of the user, a signal representing the nature of the operation to the control section 21. The display section 24 is, for example, a liquid crystal display panel and displays and outputs information according to an instruction supplied from the control section 21.

The communication section 25 transmits and receives a variety of data via a network line or mobile phone network using a communication unit such as network interface, mobile phone communication section or Bluetooth (registered trademark). The same section 25 outputs data, received via a network line or mobile phone network, to the control section 21. Further, the same section 25 sends out specified data via a network line in accordance with an instruction supplied from the control section 21.

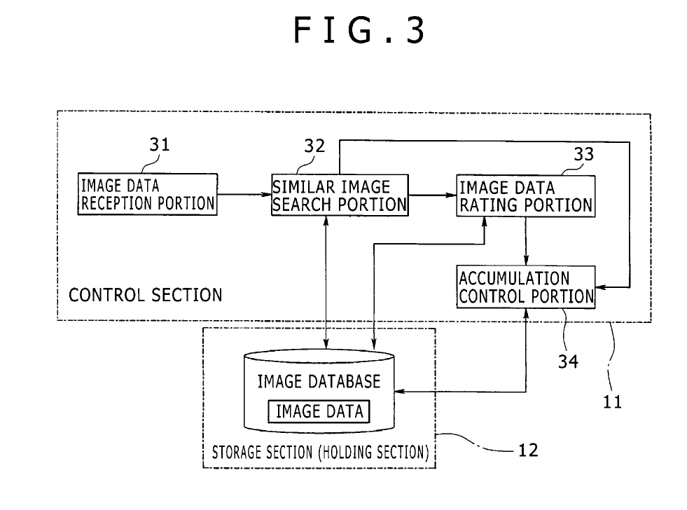

A description will be given of an example of operation of the control section 11 of the image information processor 1. In one aspect of the present embodiment, the control section 11 includes, in terms of functionality, an image data reception portion 31, similar image search portion 32, image data rating portion 33 and accumulation control portion 34 as illustrated in FIG. 3.

The image data reception portion 31 receives image data via the communication section 15 and holds the received image data in the work memory of the storage section 12 as image data to be accumulated.

The similar image search portion 32 selects, one at a time, the image data to be accumulated that is held in the work memory and investigates whether any data similar to the selected image data, i.e., data of interest, is already held in the image database of the storage section 12. More specifically, this process is conducted as follows.

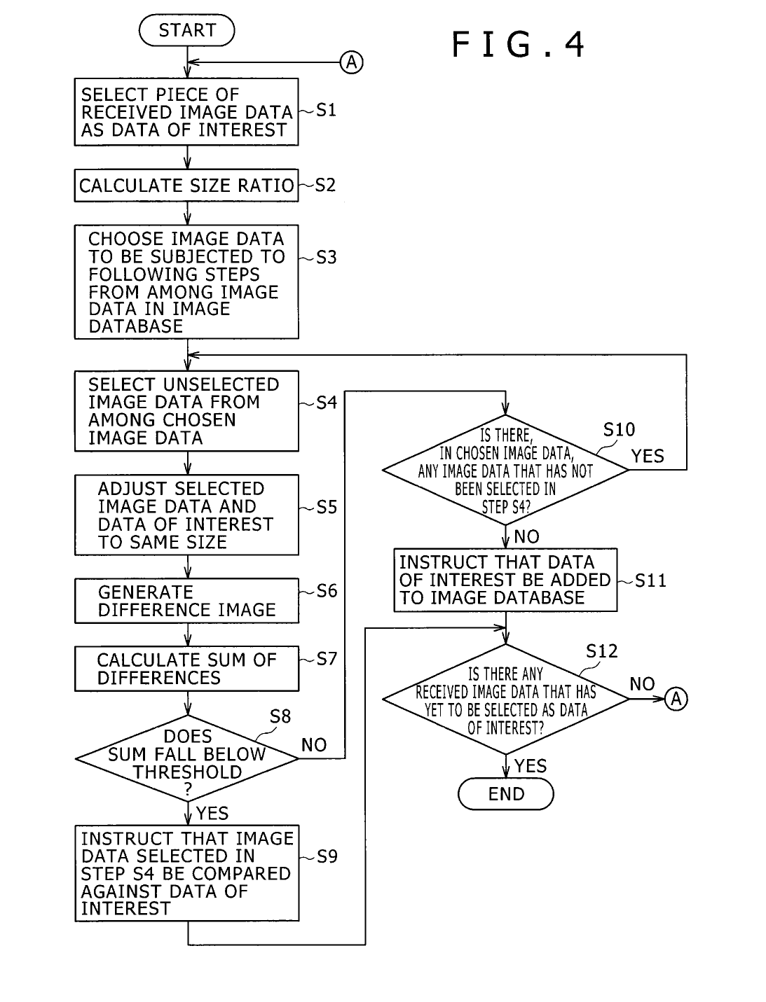

The similar image search portion 32 selects a piece of unselected image data from among the image data to be accumulated that is held in the work memory as illustrated in FIG. 4 (S1). Here, the same portion 32 calculates a size ratio (e.g., r=w/h where the ratio r is a ratio between the width w and height h) of the selected image data, i.e., the data of interest (S2). Then, the same portion 32 chooses, from among the image data held in the image database of the storage section 12, pieces of image data whose size ratios R are either the same as the calculated size ratio r of the data of interest or the reciprocal (1/r) of the calculated size ratio (S3). A case is included in which the size ratio R is the reciprocal in consideration of rotation of the orientation. It should be noted that steps S2 and S3 are designed to reduce processing load by narrowing down the image data subjected to the steps that follow. The image data subjected to the steps may be narrowed down by using file names or comparing tag information such as shooting dates instead of or in addition to using size ratios as described here. Alternatively, all the pieces of image data stored in the image database may be selected rather than narrowing down the image data.

The similar image search portion 32 selects a piece of unselected image data from among the chosen image data (S4). Then, the same portion 32 enlarges or reduces at least either the selected image data or the data of interest, converting these pieces of image data to data of the same size (S5). As an example, the similar image search portion 32 compares the size of the image data selected in step S4 and that of the data of interest, selecting the data of smaller size. Next, the same portion 32 reduces the image data whose size has not been selected to the selected size between the selected image data and the data of interest. It should be noted that if the image data selected in step S4 and the data of interest are the same in size, there is no need to enlarge or reduce the image data.

The similar image search portion 32 generates a difference image between the selected image data and the data of interest that are the same in size as a result of step S5 (S6). Here, a difference image can be generated by calculating the absolute value of the difference in pixel value between each pair of corresponding pixels. It should be noted that if either the selected image data or the data of interest is, for example, in a raw data format, it is only necessary to convert either the selected image data or the data of interest made up, for example, of raw data into a bitmap represented by a given color system having RGB values first, and then calculate the absolute value of the difference in pixel value so as to obtain a difference image. The similar image search portion 32 calculates the sum of all the values of the pixels included in the generated difference image (S7), and determines whether this sum falls below a predetermined threshold (S8). Here, when the sum falls below the predetermined threshold (when Yes), the same portion 32 determines that the image data selected in step S4 and the data of interest are similar. Then, the same portion 32 outputs information identifying the image data selected in step S4 and that identifying the data of interest to the image data rating portion 33 (S9). Then, the same portion 32 proceeds to step S12 which will be described later.

In step S8, on the other hand, if the sum does not fall below the predetermined threshold (if No), the similar image search portion 32 investigates whether any of the image data chosen in step S4 has yet to be selected (S10). Here, when there is a piece of unselected image data (when Yes), the same portion 32 returns to step S4 to repeat from the selection of other image data. On the other hand, if all the pieces of chosen image data have been selected (if No), the same portion 32 instructs the accumulation control portion 34 to newly add the image data selected in step Si to the image database (S11).

Then, the similar image search portion 32 determines whether all the pieces of image data held in the work memory as the image data to be accumulated in step Si have been selected as the data of interest (S12). When determining that all the pieces of image data have been selected (when Yes), the same portion 32 terminates the process. On the other hand, if determining in step S12 that there is a piece of image data to be accumulated in the work memory that has yet to be selected (if No), the same portion 32 returns to step S1 to continue the process (A).

The image data rating portion 33 receives two pieces of information from the similar image search portion 32, one identifying a piece of image data stored in the image database, and another identifying a piece of the image data to be accumulated that is held in the work memory. Then, the same portion 33 rates each of the two pieces of image data identified by these pieces of information based on a predetermined rating criterion, thus calculating a rating of each piece of the image data.

As an example, a rating here may be based on at least one of the size of image data to be rated, information about the image quality of the image data to be rated, and the content of the image data to be rated.

For example, the larger the size of the image data, the higher the rating may be. As a specific example, a value l=w+h, half the circumference obtained by adding the width w and height h together, may be used in an as-is manner as a rating V.

In another example, the amount of block noise produced during JPEG (Joint Photographic Experts Group) compression may be detected as information about image data quality so that the less block noise, the higher the rating may be. More specifically, derivative data is obtained by spatially differentiating image data. Then, impulse-shaped pulse signals (areas where the derivative data is greater than the predetermined value) are detected from the derivative data, thus counting the number of impulse-shaped pulse signals. In this case, the reciprocal of a count c (reciprocal is set equal, for example, to 1/(c+1) in consideration of c=0) may be used in an as-is manner as the rating V. Alternatively, the count may be multiplied, in consideration of the resolution of the image data, by a value α that becomes smaller as the resolution increases, thus using the reciprocal of the product (reciprocal is set equal, for example, to 1/(α·c+1) in consideration of c=0) as the rating V. Still alternatively, if the image data is in a JPEG format, and if this JPEG data includes information about the compression ratio, this information may be used.

As still another example, a rating based on the content of image data may be calculated. More specifically, for example, one of the reciprocals (reciprocal is set equal, for example, to 1/(p+1) or to 1/(A+1) in consideration of p=0 or A=0) may be used in an as-is manner as the rating V by using a blink detection count p obtained through blink detection or an area A over which overexposed highlight or underexposed shadow has been detected obtained through blown-out highlight and blocked-up shadow detection so that the fewer p, or the smaller A, the higher the rating is.

Alternatively, the rating V may be a combination of the ratings found based on the plurality of rating criteria. More specifically, using l, c, p and A which we have seen so far, V is set to V=αl+β/(c+1)+y/(p+1)+E/(A+1) where α, β, γand ε are respectively values with weights that have been experimentally determined as appropriate.

The image data rating portion 33 acquires a rating of each piece of the image data identified by one of the information supplied from the similar image search portion 32 as described above. Then, the same portion 33 determines whether the calculated rating of one piece of the image data stored in the image database (rating of existing data) is higher than the calculated rating of one piece of the image data to be accumulated that is held in the work memory (rating of the received data). Here, if the rating of the existing data is equal to or higher than that of the received data, the image data rating portion 33 terminates the process.

On the other hand, when determining that the rating of the received data is higher than that of the existing data, the image data rating portion 33 instructs the accumulation control portion 34 to replace the existing data with the received data together with two pieces of information supplied from the similar image search portion 32, one identifying a piece of image data stored in the image database, and another identifying a piece of the image data to be accumulated that is held in the work memory.

When receiving an instruction shown in step S11 of FIG. 4 output from the similar image search portion 32, the accumulation control portion 34 adds and accumulates the specified image data in the image database in accordance with the instruction. Further, the same portion 34 receives, from the image data rating portion 33, an instruction to replace the existing data with the received data together with two pieces of information, one identifying a piece of image data stored in the image database, and another identifying a piece of the image data to be accumulated that is held in the work memory. As a result, the accumulation control portion 34 replaces the image data identified by the supplied information and stored in the image database with the image data to be accumulated that is identified by the supplied information and held in the work memory, accumulating the image data in the image database of the storage section 12.

At this time, if tag information such as shooting date is associated with the image data to be replaced (image data originally stored in the database), the data body representing an image and part of tag information that changes as a result of the replacement of the data body such as the resolution are replaced with the content of image data identified by the supplied information and held in the work memory. In this case, tag information other than that which changes as a result of the replacement of the data body will remain unchanged from that of the image data originally stored in the image database.

In other words, if image data similar to that received as image data to be accumulated is already stored in the image database, ratings of the received image data and existing image data similar to this received image data are calculated for comparison, thus storing the higher rated image data in the image database.

It should be noted that although it has been described that a difference image data between two pieces of image data to be compared is generated for comparison of the two pieces of image data, the similar image search portion 32 according to the present embodiment may determine in a different way whether the two pieces of image data are similar. In an example of the present embodiment, for example, the similar image search portion 32 may calculate a predetermined feature quantity for each piece of the image data to be compared and determine whether the two pieces of image data are similar by comparing the feature quantities. The feature quantity here may be a hash value obtained from a well-known hash function such as MD5 or may be, for example, as follows. That is, the similar image search portion 32 may divide image data whose feature quantity is to be calculated into n×m blocks, generate a histogram of pixel values in each block, and use, as a feature quantity, a vector including n×m typical pixel values when the range of the most frequent pixel value in each of the blocks is assumed to be a typical pixel value. Further, there are also other well-known feature quantities that can be used for determination as to the similarity between two pieces of image data, and further description thereof is omitted here.

The image information processing system according to one aspect of the present embodiment is configured as described above and operates in the following manner. In the description given below, the image supplying device 2 transmits image data to be accumulated by the image information processor 1 to the same processor 1 as attached to email. In other words, we assume that the same processor 1 has been assigned a unique mail address.

The image supplying device 2 here is, for example, a smartphone such as Apple's iPhone (registered trademark) incorporating camera functionality. Further, the same device 2 has functionality to transmit and receive emails via a mobile phone line or wireless LAN network. The same device 2 stores image and other data captured by its camera functionality into the storage section 22. The user transmits this image data addressed to the image information processor 1. At this time, the same device 2 reduces the size of the image data. That is, even if the size of the original image data is 3264 by 2488 pixels, the same device 2 reduces the data, for example, down to 640 by 480 pixels before transmission.

The image information processor 1 receives the email transmitted from the image supplying device 2, extracting the image data attached to the received email and storing it into the work memory as image data to be accumulated. Here, we assume that the following pieces of image data are attached to the email transmitted from the image supplying device 2:
(1) Image data A: 640 by 480 pixels in size, data in JPEG format with 90% quality
(2) Image data B: 640 by 480 pixels in size, data in JPEG format with 90% quality
(3) Image data C: 640 by 480 pixels in size, data in JPEG format with 90% quality

Here, we assume that the quality takes on a value from 0 to 100% and that the larger the value, the lower the compression ratio (therefore higher image quality), and the smaller the value, the higher the compression ratio (therefore lower image quality) by changing the different compression ratio or quantization method.

Further, we assume that the following pieces of image data are accumulated and held in the image database of the storage section 12 of the image information processor 1.
(1) Image data B′: 640 by 480 pixels in size, data in JPEG format with 70% quality
(2) Image data C′: 3264 by 2448 pixels in size, data in JPEG format with 90% quality

Here, we assume that the image data B and image data B′ have been obtained from the same image data β as a result of reduction and quality adjustment, and that the image data C has been obtained by reducing the image data C′.

The image information processor 1 selects the image data A to be accumulated and held in the work memory as data of interest, investigating whether image data similar to the data of interest is already held in the image database of the storage section 12. Here, because no image data similar to the image data A is held in the storage section 12, the image information processor 1 newly adds the image data selected as data of interest to the image database of the storage section 12. In this stage, the image database holds the image data A, B′ and C′.

Next, the image information processor 1 selects, from among the image data held in the work memory, the image data B as data of interest, investigating whether image data similar to the data of interest is already held in the image database of the storage section 12.

Then, the same processor 1 finds the image data B′ held in the image database. The same processor 1 calculates a rating based on the predetermined criterion for each of the image data B and B′. Here, we assume that the rating V is set equal to V=αl+β/(c+1) where l=w+h is half the circumference obtained by adding the width w and height h together, and c is the amount of block noise produced during JPEG compression. Further, we assume that α=β=1. Still further, in general, the higher the quality, the less the amount c of block noise. In the description given below, therefore, we assume that the amount c of block noise at 90% quality is “10,” and that at 70% quality is “30.”

As a result, a rating V1 of the image data B is V1=1120+1/(10+1)=1120.09, and a rating V2 of the image data B′ is V2=1120+1/(30+1)=1120.03. Therefore, the rating V1 of the image data B is higher than the rating V2 of the image data B′. For this reason, the image information processor 1 replaces the image data B′ stored in the image database with the higher rated image data B, thus updating the image database. In this stage, the image database holds the image data A, B and C′.

Next, the image information processor 1 selects, from among the image data held in the work memory, the image data C as data of interest, investigating whether image data similar to the data of interest is already held in the image database of the storage section 12. Then, the same processor 1 finds the image data C′ held in the image database. The same processor 1 calculates a rating based on the predetermined criterion for each of the image data C and C′. As a result, the rating V1 of the image data C is V1=1120+1/(10+1)=1120.09, and the rating V2 of the image data C′ is V2=5712+1/(10+1)=5712.09. In other words, the rating V1 of the image data C does not become higher than the rating V2 of the image data C′. For this reason, the image information processor 1 terminates the process without replacing the image data C′ stored in the image database with the lower rated image data C. In this stage, the image database holds the image data A, B and C′.

As described above, according to one aspect of the present embodiment, the image information processor 1 accumulates and holds image data that is rated higher based on a predetermined criterion in consideration of the possible presence of a plurality of pieces of image data relating to the same image data that differ in size or in image quality due to adjustment.

It should be noted that although the image information processor 1 calculates ratings of image data stored in the image database each time the process is performed in the description given so far, the same processor 1 may calculate a rating of image data to be stored into the image database ahead of the process shown in FIG. 4 such as at the time of storage so that the rating of each piece of image data is recorded in the image database in association with corresponding image data.

Further, although ratings of image data received from the image supplying device 2 are calculated by the image information processor 1 here, the present embodiment is not limited thereto. In another aspect of the present embodiment, the image supplying device 2 may calculate ratings of image data to be transmitted to the image information processor 1 by a predetermined method (the same method as used by the image information processor 1 to calculate ratings).

In this case, when the user specifies image data to be transmitted to the image information processor 1, the image supplying device 2 calculates a rating of each piece of the specified image data, transmitting the image data to the image information processor 1 in association with the ratings obtained by the calculation. As an example, these ratings may be included as tag information to be included in the image data so that the ratings are transmitted as included in the image data.

The image information processor 1 that has received the image data and ratings holds the image data to be accumulated in association with the ratings in the work memory for processing. Then, the control section 11 operates in the following manner when serving as the image data rating portion 33. That is, the same portion 33 receives, from the similar image search portion 32, two pieces of information, one identifying a piece of image data stored in the image database, and another identifying a piece of the image data to be accumulated that is held in the work memory. Then, the same portion 33 calculates a rating of the image data identified by the information and stored in the image database. It should be noted that if a rating of image data is calculated and stored in advance in the image database, the same portion 33 may acquire the rating from the image database without calculating it.

The image data rating portion 33 determines whether the calculated or acquired rating of one piece of the image data stored in the image database (rating of existing data) is higher than the calculated rating of one piece of the image data to be accumulated that is held in the work memory (rating of the received data). Here, if the rating of the existing data is equal to or higher than that of the received data, the image data rating portion 33 terminates the process.

On the other hand, when determining that the rating of the received data is higher than that of the existing data, the image data rating portion 33 instructs the accumulation control portion 34 to replace the existing data with the received data together with two pieces of information supplied from the similar image search portion 32, one identifying a piece of image data stored in the image database, and another identifying a piece of the image data to be accumulated that is held in the work memory.

If ratings are stored in the image database in association with image data, the image data rating portion 33 may output ratings of the received data (regardless of whether the ratings have been calculated by the image information processor 1 or by the image supplying device 2) together with the instruction when instructing the accumulation control portion 34. The same portion 34 not only records the received data to the image database to replace the existing data but also records, as a rating associated with the image data, the rating output from the image data rating portion 33.

Further, the control section 21 of the image supplying device 2 may serve as the similar image search portion 32, image data rating portion 33 and accumulation control portion 34, performing the processes handled by these portions. In this case, the same section 21 communicates with the control section 11 of the image information processor 1, accessing the image data stored in the image database of the storage section 12 for processing.

Still further, although, in the description given so far, the larger the size of the image data, the higher the rating, the present embodiment is not limited thereto. If, for example, the image information processor 1 outputs images to a home television set, the same processor 1 may refer to information about the resolution of the television set to which images are output, thus establishing a criterion in such a manner that the smaller the difference between the resolution information obtained by reference (including a resolution Dw along the width and a resolution Dh along the height) and the width w and height h of the image data, the higher the rating. For example, ratings may be calculated by using the formula 1/(1+√((Dw−w)²+(Dh−h)²)).

Still further, a criterion may be established in such a manner that the closer the ratio between the width w and height h of the image data to a predetermined value, the higher the rating. As an example, the closer the ratio r of the image data to the ratio of approximately 1.78 (Dw/Dh) of full HD (Dw=1920 pixels, Dh=1080 pixels), the higher the rating. As an example, the rating is 1/(1+(r−1.78)²). As a result, the resolution of the device to which the image data is output and the image data whose ratio is closest to the screen ratio are accumulated in the image information processor 1. It should be noted that, in consideration of rotation of the orientation, two ratios r1=w/h and r2=h/w may be calculated, followed by finding two rating elements, one that is higher as r1 is closer to approximately 1.78, full HD ratio (Dw/Dh), and another that is higher as r2 is closer to approximately 1.78, full HD ratio (Dw/Dh), thus using the sum of these two rating elements as a rating.

Alternatively, the image information processor 1 according to the present embodiment may have, for example, a memory card interface for SD or other memory card and another interface for USB (Universal Serial Bus) or other device adapted to hold image data so as to receive image data to be accumulated not only from the image supplying device 2 but also from these devices. In this case, the image information processor 1 serves as the similar image search portion 32, image data rating portion 33 and accumulation control portion 34, performing the processes handled by these portions. In other words, if image data similar to that already accumulated and held in the storage section 12 is received as data to be accumulated, each piece of such data is rated by the image data rating portion 33, after which the higher rated image data is selectively accumulated and held.

It should be noted that API (Application Program Interface) adapted to store image data may perform given image processing such as resizing of the image data to be accumulated in the image supplying device 2. In this case, the hash value, the feature quantity of the resized image data, changes as a result of the resizing by the image supplying device 2. For this reason, the following problem occurs if the similar image search portion 32 determines whether two pieces of image data to be compared are same by comparing the hash values thereof.

We consider a case in which the image information processor 1 transmits image data accumulated in the image database to the image supplying device 2 for storage. In this case, the same device 2 receives the image data and resizes it at the time of storage. Then, when the resized image data is transmitted again from the image supplying device 2 to the image information processor 1, the hash value of the original image data accumulated in the image database of the same processor 1 and that of the resized image data are different. As a result, these pieces of image data are determined to be different, causing both the original data and the resized data to be accumulated.

Such a case occurs if the image supplying device 2 is used as a backup of the image information processor 1 or if image data accumulated in the image information processor 1 is held in the image supplying device 2 and carried outside.

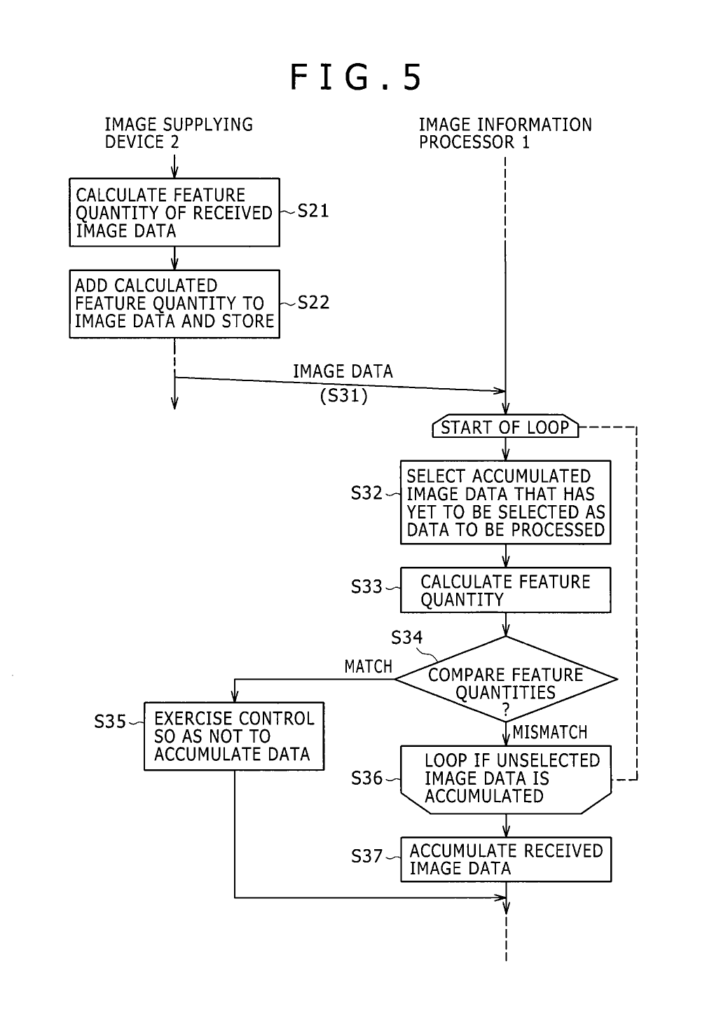

In still another aspect of the present embodiment, the control sections 11 and 21 of the image information processor 1 and image supplying device 2, respectively, may, in preparation for such a case, execute the programs stored, respectively, in the storage sections 12 and 22, thus providing the functionality illustrated in FIG. 5.

When receiving image data (the sender of image data is not limited to the image information processor 1), the control section 21 of the image supplying device 2 performs the following process for each piece of image data received. The control section 21 of the image supplying device 2 calculates a feature quantity of the image data such as hash value by a predetermined method (S21). Then, the same section 21 adds the calculated feature quantity such as hash value to the image data, for example, by including the feature quantity in the Exif information of the image data, and stores it in the storage section 22 (S22).

On the other hand, when receiving image data as data to be accumulated from the image supplying device 2 as a process handled by the similar image search portion 32 (S31), the control section 11 of the image information processor 1 compares the image data against each piece of the image data accumulated in the storage section 12. In other words, the control section 11 selects, one after another, a piece of the image data to be compared that is accumulated in the storage section 12 as data to be processed (S32) and calculates a feature quantity of the data to be processed such as hash value by a predetermined method.

The control section 11 compares the feature quantity such as hash value extracted from the Exif information included in the image data received from the image supplying device 2 against the feature quantity calculated in step S33 (S34). When the two match, the control section 11 exercises control in such a manner as not to accumulate the image data received from the image supplying device 2 in the storage section 12 (S35) first, and then terminates the process.

On the other hand, if the feature quantity such as hash value extracted from the Exif information included in the data received from the image supplying device 2 and the feature quantity calculated in step S33 do not match, the control section 11 investigates whether any image data that has yet to be selected as data to be processed is accumulated in the storage section 12. If so, the control section 11 loops back to step S32 (S36) to select a piece of unselected image data as data to be processed and repeat step S32 and subsequent steps.

On the other hand, if no piece of image data that has yet to be selected as data to be processed is accumulated in the storage section 12 (S36), the control section 11 stores the received image data in the storage section 12 (S37), terminating the process. As described above, it is possible to prevent loading of the same image data even if image data is resized at the time of storage in the image supplying device 2 by adding a pre-resizing feature quantity to image data (for example, by including Exif information) and comparing the image data against the accumulated image data using the added feature quantity.

Further, although the image supplying device 2 calculates a feature quantity such as hash value and adds it to image data here, upon receiving image data the present embodiment is not limited to this example. For example, the image information processor 1 may, at the time of transmission of image data to the image supplying device 2, calculate a feature quantity such as hash value and add the feature quantity to image data (for example, by including it in Exif information) first, and then transmit the image data to the same device 2.

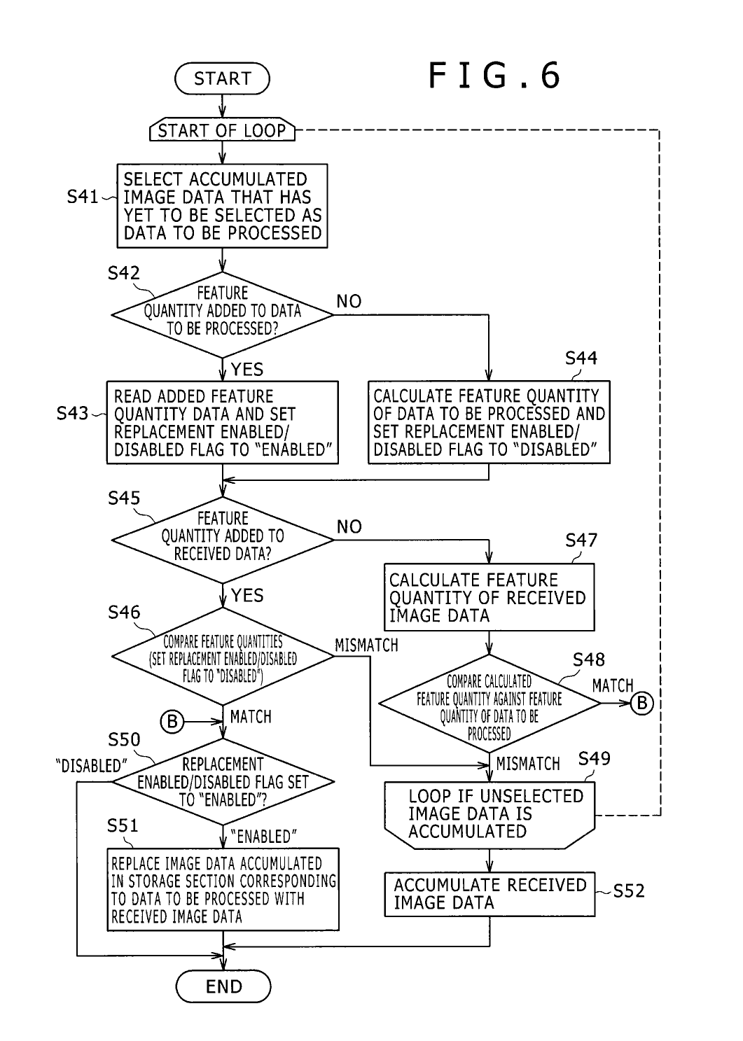

Still further, in still another aspect of the present embodiment, the control section 11 of the image information processor 1 may perform a process as illustrated in FIG. 6 in accordance with the program stored in the storage section 12. When receiving image data to be accumulated from the image supplying device 2 or other image supplying unit (including, for example, a memory card reader), the control section 11 of the image information processor 1 serves as the similar image search portion 32, selecting, one after another, a piece of the image data accumulated in the storage section 12 as data to be processed (S41) and performing the following process.

The control section 11 determines whether a feature quantity such as hash value is added to the data to be processed which is to be compared (e.g., included in Exif information) (S42). Here, when a feature quantity is added (when Yes), the control section 11 reads the feature quantity and sets the replacement enabled/disabled flag indicating whether the replacement is possible to “enabled” (S43). On the other hand, if no feature quantity is added (if No in step S42), the control section 11 calculates a feature quantity such as hash value by a predetermined method and sets the replacement enabled/disabled flag to “disabled.” Thanks to step S43 or S44, the control section 11 acquires a feature quantity of the selected data to be processed from the storage section 12.

Further, the control section 11 determines whether a feature quantity such as hash value is added to image data to be accumulated (e.g., included in Exif information) that has been received from the image supplying device 2 or other image supplying unit (S45). Here, when a feature quantity such as hash value is added to the received image data (when Yes), the control section 11 compares the added feature quantity against that of the image data extracted from the storage section 12 (S46). At this time, the control section 11 may set the replacement enabled/disabled flag to “disabled.” It should be noted that even if the replacement enabled/disabled flag is already set to “enabled,” the control section 11 resets the same flag to “disabled” in step S46. This is done to leave a possibility of acquiring image data that has yet to be resized. On the other hand, if no feature quantity is added to the received data (if No in step S45), the control section 11 calculates a feature quantity of the received data such as hash value by a predetermined method (S47) and compares the calculated feature quantity against that of the data to be processed (S48).

Then, when determining that the feature quantity of the received image data such as hash value and that of the image data extracted from the storage section 12 match as a result of steps S46 and S48, the control section 11 refers to the replacement enabled/disabled flag, determining whether the flag is set to “enabled” (S50). Here, when the same flag is set to “enabled,” the control section 11 replaces the image data corresponding to the data to be processed with the received image data (S51), storing the same data in the storage section 12. On the other hand, if the replacement enabled/disabled flag is set to “disabled” in step S50, the control section 11 terminates the process.

On the other hand, if determining that the feature quantity of the received image data such as hash value and that of the image data extracted from the storage section 12 do not match as a result of steps S46 and S48, the control section 11 investigates whether any image data that has yet to be selected as data to be processed is accumulated in the storage section 12. If so, the control section 11 loops back (S49) to select a piece of unselected image data as data to be processed and repeat step S41 and subsequent steps.

On the other hand, if a piece of image data that has yet to be compared is not available in step S49, the control section 11 accumulates the image data received to be accumulated in the storage section 12 (S52), terminating the process.

According to the description given above, if data that has not been resized by the image supplying device 2 (image data with no feature quantity added) is accumulated in the image information processor 1, there is no likelihood that data may be replaced with image data with a feature quantity added (resized and generally deteriorated image data). On the other hand, if image data with no feature quantity added (data that has not been resized by the image supplying device 2) is received when data that has been resized by the image supplying device 2 (image data with a feature quantity added) is accumulated in the image information processor 1, the accumulated image data (resized image data) can be replaced with the received image data. In other words, it is possible to accumulate less deteriorated image data by regarding addition of a feature quantity as a sign that data has been resized and can be replaced.

It should be noted that although it is determined here whether image data can be replaced based on whether a feature quantity is added, the present embodiment is not limited thereto. Instead, a flag indicating that image data has been resized, for example, may be included in Exif information, thus using the flag included in the Exif information as a flag indicating whether image data can be replaced.

It should be understood by those skilled in the art that various modifications, combinations, sub-combinations and alterations may occur depending on design requirements and other factors insofar as they are within the scope of the appended claims or the equivalents thereof.

For example, in the foregoing aspect, the image information processor 1 is formed by a plurality of hardware elements. However, part of operation of the hardware elements can also be realized by operation of a program by the control section 11 or the like.

It should be noted that the image information processor and so on according to the present disclosure have the following features.

That is, the image information processor according to one form of the present disclosure is communicably connected to a holding section that accumulates and holds image data, the information processor includes a similar image search portion, image data rating portion and accumulation control portion. The similar image search portion treats image data to be accumulated as data to be processed and determines whether image data similar to the data to be processed is held by the holding section. The image data rating portion acquires a predetermined rating of each piece of similar image data if image data similar to the image data to be accumulated is held by the holding section. The accumulation control portion compares the acquired ratings and controls in such a manner as to replace the image data held by the holding section with the image data to be processed if the image data to be processed is similar to and rated higher than the image data held by the holding section.

Here, image data to be accumulated and its rating may be received from an image supplying device adapted to supply image data to be accumulated. Alternatively, the image data reception portion may receive the image data to be accumulated from the image supplying device adapted to supply image data to be accumulated, and the similar image search portion may calculate a rating of the received image data.

Further, the rating may be calculated based on at least one of the following: image data size, information about the image quality of image data, and content of image data. Alternatively, the image data rating portion may calculate predetermined feature quantity information for each piece of image data to be accumulated and image data accumulated in the holding section, and the similar image search portion may compare the calculated feature quantities and search image data similar to the image data to be accumulated from image data held by the holding section.

Still further, a non-transitory recording media storing a program according to another form of the present disclosure stores a program that allows a computer, communicably connected to a holding section that accumulates and holds image data, to serve as a similar image search portion, image data rating portion and accumulation control portion. The similar image search portion treats image data to be accumulated as data to be processed and determines whether image data similar to the data to be processed is held by the holding section. The image data rating portion acquires a predetermined rating of each piece of similar image data if image data similar to the image data to be accumulated is held by the holding section. The accumulation control portion compares the acquired ratings and controls in such a manner as to replace the image data held by the holding section with the image data to be processed if the image data to be processed is similar to and rated higher than the image data held by the holding section.

The present disclosure permits processing in consideration of the possible presence of a plurality of pieces of image data relating to the same picture that differ in size or in image quality due to adjustment.

What is claimed is:

1. An information processing apparatus comprising:
circuitry configured to
store first image data in a memory;
acquire second image data;
determine whether the second image data is similar to the first image data;
acquire a first rating corresponding to the first image data and a second rating corresponding to the second image data; and
replace the first image data stored in the memory with the second image data acquired via a communication interface when it is determined that the second image data is similar to the first image data and the second rating is higher than the first rating.

2. The information processing apparatus of claim 1, wherein
the circuitry is configured to acquire the second image data and the second rating corresponding to the second image data from another information processing apparatus via the communication interface.

3. The image information processing apparatus of claim 1, wherein the circuitry is configured to:
acquire the second image data from another information processing apparatus via the communication interface; and
calculate the second rating corresponding to the second image data.

4. The information processing apparatus of claim 1, wherein the first and second ratings are calculated based on at least one of image data size, information indicating image quality and image data content corresponding to each of the first and second image data.

5. The information processing apparatus of claim 1, wherein the circuitry is configured to calculate feature quantity information corresponding to the first image data and the second image data.

6. The information processing apparatus of claim 5, wherein the circuitry is configured to determine whether the second image data is similar to the first image data by comparing the feature quantity information calculated for each of the first image data and the second image data.

7. The information processing apparatus of claim 1, wherein the circuitry is configured to generate a difference image between the first image data and the second image data.

8. The information processing apparatus of claim 7, wherein the circuitry generates the difference image by calculating an absolute value of differences in pixel values between each pair of corresponding pixels in the first image data and the second image data.

9. The information processing apparatus of claim 7, wherein the circuitry is configured to calculate a sum of all values of pixels included in the generated difference image.

10. The information processing apparatus of claim 9, wherein the circuitry is configured to compare the calculate sum to a predetermined threshold value, and determine that the second image data is similar to the first image data when it is determined that the calculated sum is less than the predetermined threshold.

11. A non-transitory computer-readable medium including computer program instruction, which when executed by an information processing apparatus, cause the information processing apparatus to:
determine whether acquired second image data is similar to first image data stored in a memory;
acquire a first rating corresponding to the first image data and a second rating corresponding to the second image data; and
replace the first image data stored in the memory with the second image data acquired via a communication interface when it is determined that the second image data is similar to the first image data and the second rating is higher than the first rating.

12. An image information processing system comprising:
a first information processing device; and
a second information processing device, wherein
the first information processing device includes:
a memory configured to store first image data; and
a communication interface configured to receive second image data, and one of the first information processing apparatus and the second information processing apparatus includes circuitry configured to
determine whether the second image data is similar to the first image data;
acquire a first rating corresponding to the first image data and a second rating corresponding to the second image data; and
replace the first image data stored in the memory with the second image data when it is determined that the second image data is similar to the first image data and the second rating is higher than the first rating.
